(19) United States
(12) Patent Application Publication
(10) Pub. No.: US 2005/0234150 A1
(43) Pub. Date: Oct. 20, 2005

(54) Water based pigment ink composition

(76) Inventors: Takeshi Omatsu, Osaka (JP); Kazuhiro Kawauchi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/000,984

(22) Filed: Dec. 2, 2004

(30) Foreign Application Priority Data
Dec. 3, 2003 (JP) 2003-403861
Mar. 19, 2004 (JP) 2004-079414

(51) Int. Cl. C03C 17/00; C09D 11/00

(52) U.S. Cl. 523/160; 523/161

(57) ABSTRACT

The invention provides a water based pigment ink composition comprising water, a pigment, a water-soluble resin, a phosphoric acid ester as a surfactant and an O/W type emulsion of at least one water-insoluble resin selected from the group consisting of acrylic resin, styrene resin and styrene/acrylic resin, wherein resin particles in the emulsion have an average particle diameter in the range of 50 to 200 nm, and the emulsion has a minimum film forming temperature of 50° C. or more. The water based pigment ink composition has excellent coloration in a common white paper and is excellent in the dispersion stability of a pigment and in storage stability, thus giving a handwriting at high density by use in a writing implement or an inkjet image at high density by use in an inkjet printer.

### FIELD OF THE INVENTION

The present invention relates to a water based pigment ink composition and in particular to a water based pigment ink composition which is suitable for use in, for example, writing implements and inkjet printing.

### PRIOR ART

A water based pigment ink composition has been used in writing implements such as felt-tip pen, ballpoint pen, plotter pen etc. and in inkjet printers in inkjet printing, but as compared with an ink composition using a dye as a coloring agent, the water based pigment ink composition has a problem that whether uncolored or colored, matter recorded with the ink composition on an absorptive paper, that is, a handwriting formed by writing with a writing implement or an inkjet image obtained by inkjet printing is inferior in coloration (color density) on an absorptive paper, particularly on a white paper.

The water based pigment ink composition for writing implements has an important task that the ink composition should not only have the dispersion stability of a pigment but also maintain an excellent writing property (storage stability) even after a writing implement such as a felt-tip pen has been left for a long time and excellent writing performance (cap-off property etc.) even after a writing implement such as a felt-tip pen with its cap removed has been left for a long time, to satisfy functions of the writing implement. For the ink composition for inkjet printers, the dispersion stability of a pigment in the ink composition is also an important task. Accordingly, both the water based pigment ink composition for writing implements and the water based pigment ink composition used in inkjet printers have not been sufficiently considered for the color density of handwriting or ink jet image on the absorptive surface of a general paper.

Specifically, the water based pigment ink for writing implements, upon writing on a usual absorptive paper, is absorbed into the paper, and thus a handwriting having density inherent in the ink is hardly obtainable, and particularly upon writing with black ink on a white paper, the resulting handwriting assumes a grayish color because of the above property. To cope with this problem, Japanese Patent No. 3108541 proposes the use of a certain kind of resin emulsion and saccharides in combination in a water based ink composition thereby canceling the difference in coloration due to a difference in paper qualities. However, when the resin emulsion and saccharides are thus used in combination, the dispersion stability of a pigment is adversely affected, and as a result, there is a problem that when the ink composition is used in e.g. a felt-tip pen and the pen with its point directed downward has been left for a long time, a handwriting upon writing with the pen is easily blurred, that is, the ink composition is inferior in storage stability.

To achieve the dispersion stability of a pigment in the water based pigment ink composition for inkjet printers, a pigment is dispersed in water by using a certain kind of water-soluble resin so as to prepare a water based pigment dispersion, which is then used in production of an ink composition as described in, for example, JP-A 2000-212486 and International Publication WO99/05230. The dispersion stability of a pigment in such water based pigment ink composition for inkjet printers has been improved, but when the black ink composition disclosed therein is used in inkjet printing on a white recording paper, the resulting image assumes a grayish color as well. When the colored ink composition disclosed therein is used in inkjet printing on a white recording paper, the resulting image is inferior in color density, to exhibit a dim color. To cope with this problem, one means is to increase the concentration of a pigment in the ink composition, but when the concentration of the pigment is increased, there is caused not only the problem of deterioration in the dispersion stability of the pigment in the ink composition but also the problem of clogging in an ink-discharging nozzle in an inkjet printer.

### SUMMARY OF THE INVENTION

The invention has been carried out to solve the above-described problems in the conventional water based pigment ink compositions. Accordingly, it is an object of the invention to provide a water based pigment ink composition which upon writing or inkjet printing on the absorptive surface of a usual paper, gives recorded matter (handwriting or inkjet image) having sufficiently high color density, and is excellent in the dispersion stability of a pigment in the ink composition and also in the storage stability for use by integration in a writing implement or an inkjet printer.

The invention provides a water based pigment ink composition comprising water, a pigment, a water-soluble resin, a phosphoric acid ester as a surfactant, and an O/W type emulsion of at least one water-insoluble resin selected from the group consisting of acrylic resin, styrene resin and styrene/acrylic resin, wherein the water-insoluble resin particles in the emulsion have an average particle diameter in the range of 50 to 200 nm, and the emulsion has a minimum film forming temperature of 50° C. or more.

It is preferred that the water based pigment ink composition of the invention further comprises a polyhydric alcohol in the range of 5 to 25 wt % so that the ink composition is excellent in the dispersion stability of a pigment and also in storage stability upon integration in a writing implement or an inkjet printer, or when used in a writing implement, the ink composition is prevented from being dried at the point of the writing implement, thus preventing deterioration of writing performance, or when used in an inkjet printer, the ink composition is prevented from being dried at a nozzle of the printer, thus preventing precipitation of the pigment. According to the invention, the polyhydric alcohol, particularly at least one member selected from the group consisting of a divalent alcohol and trivalent alcohol, especially at least one member selected from the group consisting of glycerin and diethylene glycol, is preferably contained in the ink composition.

It is also preferred that the water based pigment ink composition according to the invention further comprises urea or its derivative in the range of 2 to 20 wt % so that a writing implement charged with the ink composition is excellent in cap-off property, or in an inkjet printer using the same, the ink composition is not dried at a nozzle of the printer.

The water based pigment ink composition of the invention, whether black or colored, has excellent coloration even on the absorptive surface of a usual paper, gives a handwriting or inkjet image at high density and is excellent in the dispersion stability of a pigment and in storage stability for use.

### BEST MODE FOR CARRYING OUT THE INVENTION

The water based pigment ink composition of the invention comprises water, a pigment, a water-soluble resin, a phosphoric acid ester as a surfactant and an O/W type emulsion of at least one water-insoluble resin selected from the group consisting of (meth)acrylic resin, styrene resin and styrene/(meth)acrylic resin, wherein resin particles in the emulsion have an average particle diameter in the range of 50 to 200 nm, and the emulsion has a minimum film forming temperature of 50° C. or more.

The pigment used in the present invention includes various organic pigments and inorganic pigments, and are not particularly limited. The organic pigments include, for example, monoazo pigments derived from β-naphthol derivatives etc., water-insoluble azo pigments obtained by conversion, into lake, of monoazo dyes such as β-oxynaphthoic dyes etc., disazo pigment, condensed azo pigment, phthalocyanine pigment, quinacridone pigment, dioxazine pigment, perylene pigment, perinone pigment, thioindigo pigment, isoindoline pigment, isoindolinone pigment, anthraquinone pigment, diketopyrrolopyrrole pigment, quinophthalone pigment, indanthrene pigment, lake pigments obtained by conversion, into lake, of basic dyes such as triarylmethane dyes, and metal complex pigments.

Specific examples of such organic pigments include, for example, pigment yellow 1, pigment yellow 3, pigment yellow 42, pigment yellow 74, pigment yellow 83, pigment yellow 106, pigment yellow 117, pigment yellow 126, pigment yellow 183, pigment orange 5, pigment orange 16, pigment red 3, pigment red 48:1, pigment red 48:4, pigment red 101, pigment red 112, pigment red 122, pigment red 267, pigment violet 23, pigment violet 27, pigment blue 1, pigment blue 15:1, pigment blue 15:3, pigment blue 61, pigment green 7, pigment green 36 etc.

Typical examples of the inorganic pigments include, for example, iron oxide, iron ferricyanide, sulfur-containing sodium aluminate silicate, titanium dioxide, carbon black etc. Specific examples of such inorganic pigments include, for example, pigment yellow 42, pigment white 6, pigment blue 27, pigment blue 29, pigment black 7 etc.

According to the invention, the average particle diameter of the organic and inorganic pigments is usually in the range of 50 to 200 nm, preferably in the range of 60 to 150 nm, particularly preferably in the range of 70 to 120 nm. When the pigment has an average particle diameter in this range, the pigment can be dispersed stably in a solvent without deteriorating storage stability. For dispersing the pigment in a solvent, a suitable means may be used; for example, a conventionally known general means such as a bead mill, a roll mill etc. can be used. After the pigment is dispersed in a solvent by such dispersing means, coarse particles are removed from this dispersion by a method such as centrifugation, filtration or the like, whereby the point of a writing pen or a nozzle of an inkjet printer head can be prevented from being clogged. However, coarse particles mixed in the pigment may be removed after the ink composition is prepared. The pigments described above may be used alone or as a mixture of two or more thereof.

The water based pigment ink composition of the invention contains the above pigment usually in the range of 0.2 to 15 wt %, more preferably in the range of 0.5 to 12 wt %. In the water based pigment ink composition according to the present invention, the pigment is contained in the range of 1 to 15 wt %, preferably in the range of 3 to 12 wt %, most preferably in the range of 5 to 10 wt %, particularly for use as an ink composition for writing implements, or contained in the range of 0.2 to 10 wt %, preferably in the range of 0.5 to 9 wt %, for use as an ink composition for inkjet printers.

When the content of the pigment in the water based pigment ink composition is lower than 0.2 wt %, a handwriting or an inkjet image is generally poor in density and thus is not practical. On the other hand, when the content is higher than 15 wt %, the storage stability of the ink composition tends to be deteriorated, and in an extreme case, the ink composition shows an increase in viscosity and a decrease in flowability with time, and may not flow out from the point of a pen, when used in a writing implement, or may not jet from a nozzle to a recording paper, when used in an inkjet printer.

When a water based pigment ink composition for writing implements giving a handwriting having a pastel-like color without using a white inorganic pigment or white resin particles is to be obtained according to the invention, the water based pigment ink composition preferably contains the pigment in the range of 0.5 to 7 wt %, preferably 1 to 5 wt %. When the content is lower than 0.5 wt %, a handwriting becomes thin, while when the content is higher than 7 wt %, a pastel-like color cannot be obtained.

When the water based pigment ink composition for inkjet printers uses carbon black as the pigment, the specific surface area of carbon black is preferably not less than 150 m²/g so that the resulting water based pigment ink composition has a high density of black.

The water based pigment ink composition of the invention contains a water-soluble resin. The water-soluble resin not only has a role as a dispersant of the pigment into the ink composition, but also has a role as a binder for allowing a handwriting to adhere to the absorptive surface of a paper or an inkjet image to adhere to the absorptive surface of a recording paper. As the water-soluble resin, for example, an unsaturated carboxylic acid copolymer resin is preferably used in the present invention. Specific examples of the unsaturated carboxylic acid copolymer resin include, for example, styrene/(meth)acrylic acid copolymer, (meth)acrylic acid/(meth)acrylate copolymer, styrene/(meth)acrylic acid/(meth)acrylate copolymer, styrene/α-methylstyrene/(meth)acrylic acid copolymer, styrene/maleic acid copolymer etc. As used herein, (meth)acrylic acid refers to acrylic acid or methacrylic acid. These water-soluble resins may be used alone or as a mixture of two or more thereof.

According to the invention, the water-soluble resin is preferably the one usually having a weight-average molecular weight of 3000 to 30000, preferably 5000 to 15000. When the weight-average molecular weight of the water-soluble resin is too high, the resulting water based pigment ink composition has an undesirably high viscosity and is not suitable for use as an ink composition for writing implements or inkjet printers, while when the weight-average molecular weight is too low, the effect of thereof as a dispersant for the pigment is low, and thus the resulting ink composition is poor in the dispersion stability of the pigment.

The water based pigment ink composition of the invention contains the water-soluble resin usually in the range of 0.5 to 10 wt %, preferably in the range of 1 to 5 wt %, depending on the type and amount of the pigment used as described above. When the content of the water-soluble resin in the water based pigment ink composition is lower than 0.5 wt %, the dispersion stability of the pigment in the ink composition is deteriorated so that the pigment is easily aggregated. On the other hand, when the content of the water-soluble resin in the water based pigment ink composition is higher than 10 wt %, the dispersion stability of the pigment in the ink composition is deteriorated, and the viscosity of the ink composition becomes so high that the flowability is reduced, and thus the ink composition is not suitable for use in writing implements or inkjet printers.

The method of producing the water based pigment ink composition of the invention is not particularly limited, but it is usually preferred that the water-soluble resin is previously dissolved in water to form an aqueous solution which is then mixed with other components. In order to dissolve the water-soluble resin in water, it is preferred that the unsaturated carboxylic acid copolymer resin is neutralized with a basic substance such as dimethylethanolamine, triethanolamine, morpholine, ammonia water, sodium hydroxide or the like. The amount of the basic substance used may be determined most suitably depending on the acid value of the water-soluble resin used, and the resin may be neutralized by using an approximately equivalent amount. The basic substance used may be selected suitably depending on required qualities such as drying rate of a handwriting and an inkjet image. When the water-soluble resin is dissolved in water, diethylene glycol, isopropanol, ethylene glycol monobutyl ether or the like may be used as a solubilizer.

One important feature of the water based pigment ink composition of the invention lies in containing an O/W type emulsion of at least one water-insoluble resin selected from the group consisting of (meth)acrylic resin, styrene resin and styrene/(meth)acrylic resin. The (meth)acrylic resin includes, for example, homo- or copolymers of (meth)acrylates such as methyl(meth)acrylate, ethyl(meth)acrylate, butyl(meth)acrylate etc. Accordingly, the styrene/(meth)acrylic resin includes copolymers of the above-mentioed (meth)acrylate and styrene. The styrene resin includes not only homo- or copolymers of styrene and α-methylstyrene, but also styrene/butadiene copolymer (SBR), styrene/acrylonitrile copolymer (AS resin), styrene/acrylonitrile/-butadiene copolymer (ABS resin) etc. As used herein, (meth)acrylic resin refers to acrylic resin or methacrylic resin, and as described above, (meth)acrylic acid refers to acrylic acid or methacrylic acid.

According to the invention, the average particle diameter of resin particles contained in the emulsion is in the range of 50 to 200 nm, and has a minimum film forming temperature of 50° C. or more, and particularly the average particle diameter of resin particles in the emulsion is in the range of 50 to 150 nm, and the minimum film forming temperature is preferably 60° C. or more. The solids content of the emulsion used is not particularly limited, but is usually in the range of 20 to 60 wt %, preferably in the range of 30 to 50 wt %.

When the average particle diameter of resin particles in the emulsion is smaller than 50 nm, the resulting ink composition hardly forms a high-density handwriting or inkjet image on an absorptive surface. On the other hand, when the average particle diameter of resin particles in the emulsion is greater than 200 nm, the resin particles are easily settled in the ink composition; for example, when a water based pigment ink composition prepared by using such emulsion is charged into a writing implement such as a felt-tip pen and left for a long time with the point of the pen directed downward, the ink composition causes clogging at the point of the pen so that a handwriting is easily blurred; or when the ink composition is used in an inkjet printer, the composition easily causes cogging at a nozzle of the printer.

Further, when the minimum film forming temperature of the emulsion is lower than 50° C., the ink composition when used in a writing implement may not be usable in writing when the point of the pen is dried; or the ink composition when used in an inkjet printer may not be usable in inkjet printing when the temperature of the printer is increased. The upper limit of the minimum film forming temperature of the emulsion is not particularly limited, but is usually about 300° C.

According to the invention, the water based pigment ink composition contains such emulsion in an amount of 0.5 to 10 wt %, preferably 1 to 5 wt %, in terms of solids content (resin content). When the content of the emulsion in the water based pigment ink composition is higher than 10 wt % in terms of solids content, the storage stability of the resulting water based ink composition is deteriorated, while when the content of the emulsion is lower than 0.5 to 10 wt %, a handwriting or inkjet image is not formed at high color density on an absorptive surface.

Another important feature of the water based pigment ink composition according to the invention lies in containing a phosphoric acid ester as a surfactant. The phosphoric acid ester is preferably represented by the general formula (I): 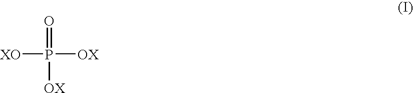
wherein X is a hydrogen atom or a monovalent group represented by the general formula (II):
R—(O—CH₂CH₂)ₙ— (II)
wherein R is an alkyl group having eight to thirty carbon atoms or an alkylphenyl group having such an alkyl group, n is a number in the range of 0 to 15 on average, and at least one of Xs is the above monovalent group. That is, the phosphoric acid ester that can be used preferably in the invention is at least one phosphoric acid ester selected from the group consisting of mono-, di- and triesters represented by the above general formula.

Accordingly, specific examples of the phosphoric acid ester that can be preferably used in the invention include, for example, polyoxyethylene alkyl ether phosphate and polyoxyethylene alkyl phenyl ether phosphate. These phosphoric acid esters are at least one selected from the group consisting of mono-, di- and triesters as described above.

By using the phosphoric acid ester as mentioned above as a surfactant according to the invention, the resulting ink composition is improved in storage stability for use in a writing implement or in an inkjet printer without deteriorating the dispersion stability of the pigment and O/W type emulsion, without giving a harmful influence on the color density of a handwriting or an inkjet image on an absorptive surface or without adversely affecting the water resistance of a handwriting or an inkjet image, although the reason for these effects has not been clarified. When a surfactant other than the phosphoric acid esters described above is used, the storage storability of the resulting ink composition is not improved, while the surface tension of ink composition tends to be significantly increased, and the above-described effect of the emulsion on a handwriting and an inkjet image on an absorptive surface cannot be sufficiently exhibited, thus causing a reduction in color density in some cases and simultaneously reducing water resistance to easily blur a handwriting and an inkjet image.

It is preferred that the water based pigment ink composition of the invention further contains a polyhydric alcohol as a first humectant in the range of 5 to 25 wt %, particularly 5 to 20 wt %, to improve the dispersion stability of the pigment and to prevent drying of the ink composition at the point of a pen, when used in a writing implement or at a nozzle of the printer, when used in an inkjet printer. According to the invention, the polyhydric alcohol, particularly at least one polyhydric alcohol selected from the group consisting of a divalent alcohol and trivalent alcohol, is preferably used as the first humectant.

The divalent alcohol includes, for example, ethylene glycol, propylene glycol, diethylene glycol etc., and the trivalent or more alcohol includes, for example, glycerin, sorbitol etc. These polyhydric alcohols may be used alone or as a mixture of two or more thereof. When the content of the polyhydric alcohol in the water based ink composition is lower than 5 wt %, the point of a pen is easily dried depending on the form of the writing implement, and particularly under a high-temperature environmental condition, blurring occurs easily even if the pen has been kept with a cap. When used in an inkjet printer, the ink composition is easily dried at the nozzle of a printer particularly under a high-temperature environmental condition, and thus smooth inkjet printing is prevented. On the other hand, when the content of the polyhydric alcohol in the water based pigment ink composition is higher than 25 wt %, the drying rate of a handwriting and an inkjet image is decreased, which is practically unfavorable.

Particularly, according to the invention, at least one member selected from the group consisting of diethylene glycol and glycerin is incorporated as the polyhydric alcohol in the range of 5 to 15 wt % thereby improving the storage stability of a writing implement (e.g. felt-tip pen) stored with the point of the pen directed downward. In the water based pigment ink composition, when the amount of at least one member selected from the group consisting of diethylene glycol and glycerin is lower than 5 wt %, the above effect is insufficient, while when the amount is higher than 15 wt %, the drying rate of a handwriting is significantly reduced in some cases.

The water based pigment ink composition of the invention preferably contains urea or its derivative as a second humectant in the range of 2 to 20 wt %, particularly in the range of 5 to 15 wt %, in order to further prevent drying of the point of a pen left in a cap-off state. The derivative of urea includes, for example, ethylene urea, propylene urea, thio urea etc. Urea and its derivatives may be used alone or as a mixture of two or more thereof. By combining the second humectant with the O/W type emulsion and the first humectant according to the invention, there is brought about a particularly outstanding effect of preventing the drying of the ink composition at the point of a writing implement (e.g. felt-tip pen) left in a cap-off state or the drying thereof in an inkjet printer.

When the amount of urea and its derivative in the water based pigment ink composition is lower than 2 wt %, the effect thereof as the humectant cannot be sufficiently obtained. On the other hand, when the amount is higher than 20 wt %, there is a disadvantage that the drying rate of a handwriting and an inkjet image is decreased, and when the writing implement is left in a cap-off state, crystals of urea or its derivatives may be precipitated at the point of the pen, or crystals may be precipitated at a nozzle of an inkjet printer. Particularly, the use of the first and second humectants in combination prevents the drying of the ink composition more effectively.

In the water based pigment ink composition of the present invention, the balance (that is, an amount excluding the ingredients described above) is water, and accordingly the amount of water is regulated such that the ingredients described above are contained in the ratio described above. However, the water based pigment ink composition according to the invention may if necessary contain ingredients other than those described above, for example a preservative, an anti-fungus agent, a pH regulator, a rust preventive, a surfactant etc. in such a range that the above-described features of the water based pigment ink composition of the present invention are not deteriorated.

### EXAMPLES

Hereinafter, the present invention is described in more detail by reference to the Examples, but the present invention is not limited to the Examples.

Examples of Ink Compositions for Writing Implements

The color density of each of the water based pigment ink compositions obtained in the Examples and Comparative Examples described later, and the storage stability and cap-off property of each ink composition used in a writing implement, were examined in the following manner.

Color Density of Handwriting

A felt-tip pen (writing line width 0.6 mm) that is one kind of writing implement equipped with an ink reservoir made of a fiber bundle chip was charged with the water based pigment ink composition, and then used in writing on a white PPC (plane paper copier) paper, that is, a usual copying paper. With respect to the water based black ink composition, “good” was given when its handwriting was dark black, while “bad” was given when it was grayish. With respect to the water based colored ink composition, “good” was given when its handwriting was highly dense and vivid, while “bad” was given when it had a subdued color.

Storage Stability of Ink Composition

The felt-tip pen charged with the ink composition was allowed to stand with its point directed downward, then left in this state for one month at a temperature of 50° C., and used to draw ten circles of 15 mm in diameter successively. “5” was given where normal writing was feasible while the first circle was drawn; “4” was given where normal writing was feasible while the second circle was drawn; “3” was given where normal writing was feasible until or while the fifth circle was drawn; “2” was given where normal writing was feasible until or while the tenth circle was drawn; and “1” was given where the handwriting was blurred while the tenth circle was drawn.

Cap-Off Property

After a cap was removed from a felt-tip pen charged with the ink composition, the pen was left for 5 hours under the environmental conditions of a temperature of 20° C. and 65% relative humidity and then used to draw 10 circles of 15 mm in diameter successively. “5” was given where normal writing was feasible while the first circle was drawn; “4” was given where normal writing was feasible while the second circle was drawn; “3” was given where normal writing was feasible until or while the fifth circle was drawn; “2” was given where normal writing was feasible until or while the tenth circle was drawn; and “1” was given where the handwriting was blurred while the tenth circle was drawn.

The water based pigment dispersions used in the Examples and Comparative Examples below were prepared in the following manner.

Water Based Black Pigment Dispersion A

20 wt % water-soluble resin (Joncryl 683 manufactured by Johnson Polymer), 2 wt % sodium hydroxide and 78 wt % deionized water were mixed and stirred under heating to prepare an aqueous resin solution. 25 wt % of this aqueous resin solution, 25 wt % carbon black (Monac 800 manufactured by Cabot Corporation), 20 wt % ethylene glycol and 30 wt % deionized water were stirred, mixed, and dispersed with a bead mill, to give water based black pigment dispersion A.

Water Based Pink Pigment Dispersion B

20 wt % water-soluble resin (Joncryl 683, styrene/acrylic acid resin, acid value 160, molecular weight 8000, manufactured by Johnson Polymer), 2 wt % sodium hydroxide and 78 wt % deionized water were mixed and stirred under heating to prepare an aqueous resin solution. 25 wt % of this aqueous resin solution, 25 wt % quinacridone pigment (Chromophthal Pink PT manufactured by Ciba Specialty Chemicals Inc.), 20 wt % ethylene glycol and 30 wt % deionized water were stirred, mixed, and dispersed with a bead mill, to give water based black pigment dispersion B.

### Example 1

6 wt % acrylic resin emulsion (Nicazole A-19, minimum film forming temperature 75° C., solids content 46 wt %, average particle diameter 99 nm, manufactured by Nippon Carbide Industries Co., Inc.), 0.6 wt % phosphoric acid ester surfactant (Phosphanol PE-510, a mixture of polyoxyethylene alkyl phenyl ether monophosphate, diphosphate and (a very small amount of) triphosphate, manufactured by Toho Chemical Industry Co., Ltd.), 10 wt % glycerin, 15 wt % urea, 32.2 wt % deionized water, 0.1 wt % antifungal agent (Coatside H manufactured by Takeda Chemical Industries, Ltd.) and 0.1 wt % preservative (Proxel XL-2 manufactured by Avecia K.K.) were added to 36 wt % water based black pigment dispersion A, then stirred, mixed and centrifuged to remove coarse particles, whereby a water based black pigment ink composition was obtained.

The color density of a handwriting with this ink composition was “good”, and the storage stability at use and cap-off property were “5” respectively.

### Example 2

6 wt % styrene/acrylic resin emulsion (Polyzole AP-6730, minimum film forming temperature 78° C., solids content 45 wt %, average particle diameter 108 nm, manufactured by Showa Highpolymer Co., Ltd.), 0.8 wt % phosphoric acid ester surfactant (Phosphanol PE-510 manufactured by Toho Chemical Industry Co., Ltd.), 10 wt % glycerin, 15 wt % urea, 32.0 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 36 wt % water based black pigment dispersion A, then stirred, mixed and centrifuged to remove coarse particles, whereby a water based black pigment ink composition was obtained. The color density of a handwriting with this ink composition was “good”, and the storage stability at use and cap-off property were “5” respectively.

### Example 3

7 wt % acrylic resin emulsion (Movinyl 790, minimum film forming temperature 220° C., solids content 40 wt %, average particle diameter 83 nm, manufactured by Clariant Polymer Co., Ltd.), 1.0 wt % phosphoric acid ester surfactant (Phosphanol PE-510 manufactured by Toho Chemical Industry Co., Ltd.), 10 wt % glycerin, 15 wt % urea, 30.8 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 36 wt % water based black pigment dispersion A, then stirred, mixed and centrifuged to remove coarse particles, whereby a water based black pigment ink composition was obtained. The color density of a handwriting with this ink composition was “good”, and the storage stability at use and cap-off property were “5” respectively.

### Example 4

6 wt % acrylic resin emulsion (Nicazole A-19, minimum film forming temperature 75° C., solids content 46 wt %, average particle diameter 99 nm, manufactured by Nippon Carbide), 0.6 wt % phosphoric acid ester surfactant (Phosphanol PE-510 manufactured by Toho Chemical Industry Co., Ltd.), 10 wt % glycerin, 10 wt % urea, 41.2 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 32 wt % water based pink pigment dispersion B, then stirred, mixed and centrifuged to remove coarse particles, whereby a water based pink pigment ink composition was obtained. The color density of a handwriting with this ink composition was “good”, and the storage stability at use and cap-off property were “5” respectively.

### Example 5

A water based black pigment ink composition was obtained in the same manner as in Example 3 except that ethylene glycol was used in place of glycerin. The color density of a handwriting with this ink composition was “good”, and the storage stability at use and cap-off property were “4” respectively.

### Example 6

A water based black pigment ink composition was obtained in the same manner as in Example 3 except that urea was changed by deionized water. The color density of a handwriting with this ink composition was “good”, the storage stability at use was “4”, and the cap-off property was “1”.

### Comparative Example 1

0.6 wt % phosphoric acid ester surfactant (Phosphanol PE-510 manufactured by Toho Chemical Industry Co., Ltd.), 10 wt % glycerin, 15 wt % urea, 30.2 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 44 wt % water based pigment dispersion A, then mixed, stirred, and centrifuged to remove coarse particles, whereby a water based pigment ink composition was obtained. The color density of a handwriting with this ink composition was “bad”, the storage stability at use was “1”, and the cap-off property was “5”.

### Comparative Example 2

8 wt % styrene/acrylic resin emulsion (Nicazole RX-3006E, minimum film forming temperature 70° C., solids content 39 wt %, average particle diameter 210 nm, manufactured by Nippon Carbide), 0.6 wt % phosphoric acid ester surfactant (Phosphanol PE-510 manufactured by Toho Chemical Industry Co., Ltd.), 10 wt % glycerin, 15 wt % urea, 30.2 wt % deionized water, 0.1 wt % antifungal agent (Coatside H manufactured by Takeda Chemical Industries, Ltd.) and 0.1 wt % preservative (Proxel XL-2 manufactured by Avecia K.K.) were added to 36 wt % water based black pigment dispersion A, then stirred, mixed and centrifuged to remove coarse particles, whereby a water based black pigment ink composition was obtained. The color density of a handwriting with this ink composition was “good”, the storage stability at use was “2”, and the cap-off property was “5”.

### Comparative Example 3

A water based black pigment ink composition was obtained in the same manner as in Example 3 except that dioctylsulfosuccinic acid (Sanmoline OT-70 manufactured by Sanyo Chemical Industries, Ltd.) was used in place of the phosphoric acid ester surfactant. The color density of a handwriting with this ink composition was “good”, the storage stability at use was “2”, and the cap-off property was “5”.

### Comparative Example 4

0.6 wt % phosphoric acid ester surfactant (Phosphanol PE-510 manufactured by Toho Chemical Industry Co., Ltd.), 10 wt % glycerin, 10 wt % urea, 39.2 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 40 wt % water based pink pigment dispersion B, then stirred, mixed and centrifuged to remove coarse particles, whereby a water based pink pigment ink composition was obtained. The color density of a handwriting with this ink composition was “good”, the storage stability at use was “3”, and the cap-off property was “5”.

The water based pigment ink composition of the invention contains an O/W type emulsion and a phosphoric acid ester as a surfactant, and gives a handwriting at high color density and is excellent in storage stability, when used in a writing implement. According to the invention, a water based pigment ink composition also excellent in cap-off property can be obtained by using a polyhydric alcohol or urea or its derivatives.

The water based pigment ink composition according to the invention can be used in writing implements having a fiber bundle as an ink reservoir, such as a marking pen and a ballpoint pen, and as a water based pigment ink composition for recording, printing, stamping etc.

Examples of Ink Compositions for Inkjet Printers

Each of the ink compositions obtained in the Examples and Comparative Examples below was applied by an applicator onto a white paper to prepare a test sample, which was then measured for its color density, that is, L* value, by using a colorimeter CR-241 manufactured by Minolta Co., Ltd. According to this test, a lower L* value is indicative of higher color density, while a higher L* value is indicative of lower color density. In another test, color density was evaluated with naked eyes. When the color was dense, “good” was given; when the color was slightly pale, “slightly bad” was given; and when the color was pale, “bad” was given. In evaluation of coloration, the ink composition was used in inkjet printing on a coated paper (non-absorptive surface) and a common paper (absorptive surface), and the resulting inkjet images on the two papers were visually compared with each other to determine whether there was a difference in color density between the two recording papers. When there was no difference in the color density of the ink jet image between the coated paper and the common paper, “not different” was given; when the color density was lightly lower on the common paper than the coated paper, “slightly different” was given; and when the color density was lower on the common paper than the coated paper, “different” was given.

The aqueous resin solution and the water based pigment dispersions used in the Examples and Comparative Examples below were prepared in the following manner.

Preparation of Aqueous Resin Solution

20.0 parts by weight of a water-soluble resin (Joncryl 683 manufactured by Johnson Polymer) were added to 76.5 parts by weight of deionized water under stirring, and then 3.5 parts by weight of 28 wt % ammonia water were added thereto. Then, the mixture was heated to about 60° C. to dissolve the resin and then cooled to room temperature under stirring to give an aqueous resin solution.

Preparation of Water Based Black Pigment Dispersion C

25.0 parts by weight of the above aqueous resin solution, 25.0 parts by weight of carbon black (Monac 800 manufactured by Cabot Corporation), 20.0 parts by weight of ethylene glycol and 30.0 parts by weight of deionized water were mixed under stirring, then defoamed, and dispersed with a bead mill, to give water based black pigment dispersion C.

Preparation of Water Based Blue Pigment Dispersion D

25.0 parts by weight of the above aqueous resin solution, 25.0 parts by weight of a blue pigment (Fastgen Blue TGR manufactured by Dainippon Ink and Chemicals, Incorporated), 20.0 parts by weight of ethylene glycol and 30.0 parts by weight of deionized water were mixed under stirring, then defoamed, and dispersed with a bead mill, to give water based blue pigment dispersion D.

Preparation of Water Based Red Pigment Dispersion E

25.0 parts by weight of the above aqueous resin solution, 25.0 parts by weight of a red pigment (Fastgen Super Magenta RG manufactured by Dainippon Ink and Chemicals, Incorporated), 20.0 parts by weight of ethylene glycol and 30.0 parts by weight of deionized water were mixed under stirring, then defoamed, and dispersed with a bead mill, to give water based red pigment dispersion E.

Preparation of Water Based Yellow Pigment Dispersion F

25.0 parts by weight of the above aqueous resin solution, 25.0 parts by weight of a yellow pigment (Pigment Yellow IRC manufactured by Sanyo Shikiso K.K.), 20.0 parts by weight of ethylene glycol and 30.0 parts by weight of deionized water were mixed under stirring, then defoamed, and dispersed with a bead mill, to give water based yellow pigment dispersion F.

### Example 7

6 wt % acrylic resin emulsion (Movinyl 790, minimum film forming temperature 220° C., solids content 40 wt %, average particle diameter 83 nm, manufactured by Clariant Polymer Co., Ltd.), 0.6 wt % phosphoric acid ester surfactant (Phosphanol PE-510 manufactured by Toho Chemical Industry Co., Ltd.), 10 wt % glycerin, 15 wt % urea, 32.2 wt % deionized water, 0.1 wt % antifungal agent (Coatside H manufactured by Takeda Chemical Industries, Ltd.) and 0.1 wt % preservative (Proxel XL-2 manufactured by Avecia KK) were added to 36 wt % water based black pigment dispersion C, then stirred, mixed and centrifuged to remove coarse particles, whereby a water based black pigment ink was obtained. The color density of a handwriting with this ink composition was 29.0 in terms of L* value, the color density by visual evaluation was “good”, and the coloration was “not different”.

### Example 8

A water based black pigment ink was obtained in the same manner as in Example 7 except that 6 wt % acrylic resin emulsion (Nicazole A-19, solids content 46 wt %, average particle diameter 99 nm, manufactured by Nippon Carbide) was used in place of the acrylic resin emulsion (Movinyl 790, minimum film forming temperature 220° C., solids content 40 wt %, average particle diameter 83 nm, manufactured by Clariant Polymer Co., Ltd.).

The color density of this ink composition was 28.0 in terms of L* value, the color density by visual evaluation was “good”, and the coloration was “not different”. The possibility of clogging in a printer head was shown to be “small”.

### Example 9

A water based pigment ink was obtained in the same manner as in Example 7 except that the water based blue pigment dispersion D was used in place of the water based black pigment dispersion C. The color density of this ink composition was 53.0 in terms of L* value, the color density by visual evaluation was “good”, and the coloration was “not different”.

### Example 10

A water based pigment ink was obtained in the same manner as in Example 7 except that the water based red pigment dispersion E was used in place of the water based black pigment dispersion C. The color density of this ink composition was 56.0 in terms of L* value, the color density by visual evaluation was “good”, and the coloration was “not different”.

### Example 11

A water based pigment ink was obtained in the same manner as in Example 7 except that the water based yellow pigment dispersion F was used in place of the water based black pigment dispersion C. The color density of this ink composition was 85.0 in terms of L* value, the color density by visual evaluation was “good”, and the coloration was “not different”.

### Comparative Example 5

10 wt % glycerin, 15 wt % urea, 30.2 wt % deionized water and 0.1 wt % antifungal agent (Coatside H manufactured by Takeda Chemical Industries, Ltd.) were added to 44 wt % water based black pigment dispersion C, then stirred, mixed and centrifuged to remove coarse particles, whereby a water based pigment ink was obtained. The color density of this ink composition was 30.0 in terms of L* value, the color density by visual evaluation was “slightly bad”, and the coloration was “slightly different”.

### Comparative Example 6

10 wt % glycerin, 15 wt % urea, 38.2 wt % deionized water, 0.1 wt % antifungal agent (Coatside H manufactured by Takeda Chemical Industries, Ltd.) and 0.1 wt % preservative (Proxel XL-2 manufactured by Avecia K.K.) were added to 36 wt % water based black pigment dispersion C, then stirred, mixed and centrifuged to remove coarse particles, whereby a water based black pigment ink was obtained. The color density of this ink composition was 35.0 in terms of L* value, the color density by visual evaluation was “bad”, and the coloration was “different”.

### Comparative Example 7

A water based pigment ink was obtained in the same manner as in Comparative Example 6 except that the water based blue pigment dispersion D was used in place of the water based black pigment dispersion C. The color density of this ink composition was 56.0 in terms of L* value, the color density by visual evaluation was “bad”, and the coloration was “different”.

### Comparative Example 8

A water based pigment ink was obtained in the same manner as in Comparative Example 6 except that the water based red pigment dispersion E was used in place of the water based black pigment dispersion C. The color density of this ink composition was 60.0 in terms of L* value, the color density by visual evaluation was “slightly bad”, and the coloration was “different”.

### Comparative Example 9

A water based pigment ink was obtained in the same manner as in Comparative Example 6 except that the water based yellow pigment dispersion F was used in place of the water based black pigment dispersion C. The color density of this ink composition was 88.0 in terms of L* value, the color density by visual evaluation was “bad”, and the coloration was “different”.

As shown in the above results, the water based pigment ink compositions according to the invention, when used in an inkjet printer, give inkjet images having visually particularly high color density to an absorptive surface, while the water based pigment ink compositions produced in the Comparative Examples give inkjet images having visually particularly low color density and significantly different in coloration from one another depending on the qualities of paper used.

1. A water based pigment ink composition comprising water, a pigment, a water-soluble resin, a phosphoric acid ester as a surfactant, and an O/W type emulsion, in the range of 0.5 to 10 wt % in terms of solids content, of at least one water-insoluble resin selected from the group consisting of (meth)acrylic resin, styrene resin and styrene/(meth)acrylic resin, wherein resin particles in the emulsion have an average particle diameter in the range of 50 to 200 nm, and the emulsion has a minimum film forming temperature of 50° C. or more.

2. The water based pigment ink composition according to claim 1, wherein the phosphoric acid ester is represented by the general formula (I): 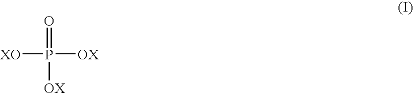
wherein X is a hydrogen atom or a monovalent group represented by the general formula (II):
R—(O—CH₂CH₂)ₙ— (II)
wherein R is an alkyl group having eight to thirty carbon atoms or an alkylphenyl group having such an alkyl group, n is a number in the range of 0 to 15 on average, and at least one of Xs is the above monovalent group.

3. The water based pigment ink composition according to claim 1, which further comprises a polyhydric alcohol in the range of 5 to 25 wt %.

4. The water based pigment ink composition according to claim 3, which comprises at least one polyhydric alcohol selected from the group consisting of diethylene glycol and glycerin in the range of 5 to 15 wt %.

5. The water based pigment ink composition according to claim 1, which comprises urea or its derivative in the range of 2 to 20 wt %.

6. The water based pigment ink composition according to claim 1, which comprises the pigment in the range of 0.2 to 15 wt %.

7. The water based pigment ink composition for writing implements according to claim 1, which comprises the pigment in the range of 1 to 15 wt %.

8. The water based pigment ink composition for inkjet printers according to claim 1, which comprises the pigment in the range of 0.2 to 10 wt %.

9. The water based pigment ink composition for inkjet printers according to claim 8, wherein the pigment is carbon black having a specific surface area of not less than 150 m²/g.

10. The water based pigment ink composition according to claim 1, wherein the water-soluble resin is at least one unsaturated carboxylic acid copolymer resin selected from the group consisting of styrene/(meth)acrylic acid copolymer, (meth)acrylic acid/(meth)acrylate copolymer, styrene/(meth)acrylic acid/(meth)acrylate copolymer, styrene/a-methylstyrene/(meth)acrylic acid copolymer and styrene/-maleic acid copolymer.
